(19) United States
(12) Patent Application Publication
(10) Pub. No.: US 2015/0068117 A1
(43) Pub. Date: Mar. 12, 2015

(54) ADJUSTABLE PLANT CAGE AND KIT

(71) Applicant: ANTHONY JAMES SAVINO, Kennewick, WA (US)

(72) Inventor: ANTHONY JAMES SAVINO, Kennewick, WA (US)

(21) Appl. No.: 14/025,650

(22) Filed: Sep. 12, 2013

(51) Int. Cl. A01G 9/12

(52) U.S. Cl. CPC A01G 9/12
USPC 47/45

(57) ABSTRACT

The plant cage of the present invention comprises a plurality of vertical risers with a plurality of horizontal cross section assemblies that are capable of being raised or lowered on the vertical risers as well as increasing or decreasing in diameter by transitioning the inner bore of the larger horizontal tube.

### FIELD OF THE INVENTION

This invention relates to supports for plants. Further, the invention relates to an adjustable plant support device that will allow for vertical and horizontal adjustment for plant support. Further this device provides for the integration of the above ground plant support structure with the planting container. Additionally this device allows the above ground support structure to be built around existing plants.

### BACKGROUND OF THE INVENTION

Plant cage and lattice structures are known including Stone U.S. Pat. No. 4,922,653; U.S. Pat. No. 6,729,070 to Locke et al; U.S. Pat. No. 7,654,038 to Simmons; U.S. Pat. No. 7,918,051 to Early; U.S. Pat. No. 8,356,445 to Colquhoun; U.S. Patent Application No. 20080263949 to Early; U.S. Patent Application No. 20100005714 to Aiken; U.S. Patent Application No. 20130212940 to Blyden; U.S. Patent Application No. 20050086859 to Bruno el al.

### SUMMARY OF THE INVENTION

In its broad concept, the plant cage of the present invention includes a plurality of vertical risers with a plurality of horizontal cross section assemblies that are capable of being raised or lowered on the vertical risers as well as increasing or decreasing in diameter by traversing the inner bore of the larger horizontal tube.

### BRIEF DESCRIPTION OF THE FIGURES

The foregoing and other features and advantages of the present invention will become more readily appreciated as the same become better understood by reference to the following detailed description of the preferred embodiment of the invention when taken in conjunction with the accompanying drawings, wherein:

FIG. 1 is a perspective view illustrating a plurality of vertical support (120), cross section assembly (200), container mount assembly (300), container (500), horizontal transversing tube section (400), outer tube (410), inner tube (420), bushing (435) and position holder (430).

FIG. 2 shows the cross section assembly (200) outer tube (410), inner tube (420), bushing (435), position holder (430) and 4 way cross (210).

FIG. 3 illustrates the container mount assembly (300) including a pot mount coupling (310), a plug (320), u-channel (330), plug screw (340) and nut (350).

FIG. 4 shows the transitioning tube section (400) including outer tube (410), inner tube (420) and position holder (430).

FIG. 5 shows breakdown sections for storage including the outer tube (410), the inner tube (420), the position holder (430), the container mount assembly (300), 4 way cross (200), vertical support (120), container mount coupling (310), and ground steak (510).

### DETAILED DESCRIPTION OF THE INVENTION

The adjustable plant cage and Kit (1) comprises a plurality of elongated tubular vertical supports (120) and a plurality of 4 way cross assemblies (200). The said 4 way cross assemblies (200) are comprised in part of a tubular cross fitting (210) with each of the vertical supports (120) sized to be movably received and are movably received vertically through the cross fitting (210) of at least one cross section assembly (200).

There is at least one transitioning tube section (400) intermediate each 4 way cross assembly (200). The said at least one transitioning tube section (400) is comprised of an outer tube (410) and an inner tube (420); the said outer tube (410) is sized to slideably receive the said inner tube (420). Each 4 way cross assembly (200) is sized to horizontally and slideably receive and does receive the tube extending from the most proximal transitioning tube section (400).

A container mount assembly (300) is affixed, by container mount assembly (300) affixing means, to each of the vertical supports (120) most proximal to a container (500) or the planting medium wherein a plant is or is to be located. The said container mount assembly (300) is in alignment with the upwardly extending vertical support (120).

The plurality of vertical supports (120), plurality of 4 way cross assemblies (200) and the said transitioning tube section are comprised of a rigid or semi-rigid tubular material. The material may include metals and plastics. In the preferred embodiment the preferred material is PEX tubing and fittings. However, PVC is recognized by those of ordinary skill in the tubing arts to also be a material which is satisfactory for use. It will be appreciated by those of ordinary skill in tube arts that a bushing (435) may be required to mate the outer tube (410), inner tube (420) with the tubular cross (210).

The said 4 way cross assemblies (200) are comprised in part of a cross fitting (210). Each vertical support (120) is sized to be movably received and is movably received vertically through the cross fitting (210) of at least one cross section assembly (200) and likely more than one cross section assembly (200). A transitioning tube section (400) is intermediate each 4 way cross assembly (200). The at least one transitioning tube section (400) is comprised of an outer tube (410) and an inner tube (420). The said outer tube (410) is sized to movably receive the said inner tube (420) and each 4 way cross assembly (200) is sized to horizontally receive and does receive the tube extending from the most proximal transitioning tube section (400).

A container mount assembly (300) is affixed, by container mount assembly (300) affixing means, to each of the vertical supports (120) most proximal to a container (500) or planting medium wherein a plant is or is to be located. The container mount assembly (300) is in alignment with the upwardly extending vertical support (120). Where the plant cage (1) is used with a container (500) the container mount assembly (300) is a bracket formed to attach to a container (500) affixed, by container mount assembly (300) affixing means, to each of the plurality of vertical supports (120). The container mount assembly (300) is affixed to the vertical support (120) most proximal to a container (500) or the planting medium wherein a plant is or is to be located. The container mount assembly (300) is in alignment with the upwardly extending vertical support (120).

Where the plant cage (1) is used with a container (500) the container mount assembly (300) bracket, in the kit, is comprised of a container mount coupling (310), comprising a straight coupling, a plug (320) and a u-channel (330). The vertical support (120) most proximal to the container (500) is sized to and is received into the said container mount coupling (310) and the plug (320) is sized to and is received upwardly into the said container mount coupling (310). The plug (320), recognized by those of ordinary skills in tube arts, is received into and closes a tube. A plug aperture formed in the plug (320) and a container aperture, formed in the top edge of the container, are aligned. The said u-channel (330) is an open rectangular U-Channel having a u-channel (330) aperture in the closed side of the U-Channel opposing the open side. The open side of the u-channel (330) is placed against the underside of the top edge of the container with the u-channel (330) aperture in alignment with the plug aperture and container aperture with said alignment receiving the downwardly extending plug bolt (340) which is rigidly secured by bolt/nut interconnection by said nut (350). It is commonly recognized that a variety of interconnection configurations, between the vertical supports (120) will be accomplished by other than nut/bolt fixtures and that such interconnection will be equally recognized by those of ordinary skill.

Where the plant cage (1) is used with a plant in earth or a potting mixture, each o the of vertical supports (120) are sized to and are received most proximal to the earth or a potting mixture, into a container mount coupling (310). A tubular spike (510) is sized to and is received upwardly into the said container mount coupling (310) to be inserted into the earth or potting mixture.

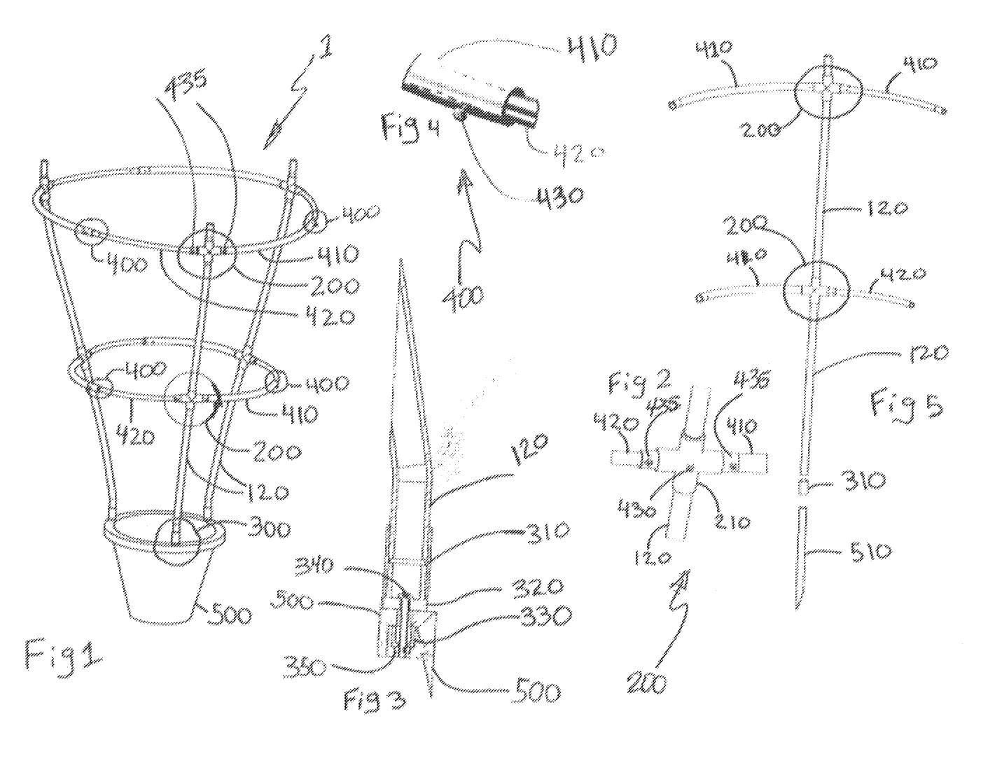

Tubular interconnections for the transitioning tube sections (400) and each 4 way cross assembly (200) are generally realized by use of position holders (430), represented as set screws in the Figures, the function of which can be realized by many different bracket structures as is known to those of ordinary skill in the art of holding or securing tubing and fittings from movement from the desired location. In the preferred embodiment of the invention, illustrated in FIG. 1, there will be three of the assemblies seen in FIGS. 1 and 5 that are connected to a container (500) as seen in FIGS. 1 and 3 or to the ground as seen as suggested by FIG. 5. The transitioning tube sections (400) are seen in detail in FIG. 4 with the use of a position holder observed in FIG. 4.

The ability to assemble and dissemble the invention is facilitated by the use of the 4 way cross (210) which is sized to and can slide the entire length of each vertical support (120) and be removed on either end. This allows for the transitioning tube sections (400) to be adjusted to any desired height and allow the cage to “grow with the plant”.

Disassembly of the plant cage is accomplished by separating each of vertical supports (120) from the container mount assembly (300) or ground steak 510 and loosening set-screws (430) to allow the inner tubes (420) to slide out of the outer tubes (410). The resulting disassembly results in easily storable assemblies as seen in FIG. 5.

A kit will generally be comprised as follows: 3 each Vertical Supports (120), 6 each cross section assemblies (200), 3 container mount assemblies (300), 3 straight couplings (310), 3 plugs (320), 3 u-channels (330), 3 bolts (340) and 3 nuts (350), 6 horizontal transitioning sections (400) comprising 3 outer tubes (410) and 3 inner tubes (420), 6 position holders (430), one container (500) and 3 steaks (510).

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims. Various features of the invention are set forth in the appended claims.

1. An adjustable plant cage (1) comprising:
a plurality of vertical supports (120); and,
a plurality of 4 way cross assemblies (200); and,
the said 4 way cross assemblies (200) comprised in part of a cross fitting (210); and,
each said vertical support (120) is sized to be movably received and is movably received vertically through the cross fitting (210) of at least one cross section assembly (200); and,
at least one transitioning tube section (400) is intermediate each 4 way cross assembly (200); the said at least one transitioning tube section (400) is comprised of an outer tube (410) and an inner tube (420); the said outer tube (410) is sized to slideably receive the said inner tube (420); and,
each 4 way cross assembly (200) is sized to horizontally receive and does slideably receive the tube extending from the most proximal transitioning tube section (400); and,
a container mount assembly (300) is affixed, by container mount assembly (300) affixing means, to each of said plurality of vertical supports (120) most proximal to a container (500) or the planting medium wherein a plant is or is to be located; the said container mount assembly (300) is in alignment with the upwardly extending vertical support (120).

2. An adjustable plant cage (1) depending from claim 1 further comprising:
the said plurality of vertical supports (120), said plurality of 4 way cross assemblies (200) and the said transitioning tube section are comprised of a rigid or semi-rigid tubular material; and,
the said 4 way cross assemblies (200) comprised in part of a cross fitting (210); and,
each said vertical support (120) is sized to be movably received and is movably received vertically through the cross fitting (210) of at least one cross section assembly (200); the cross fitting (210) is retained in position by position holder (430); and,
at least one transitioning tube section (400) is intermediate each 4 way cross assembly (200); the said at least one transitioning tube section (400) is comprised of an outer tube (410) and an inner tube (420); the said outer tube (410) is sized to movably receive the said inner tube (420); and,
each 4 way cross assembly (200) is sized to horizontally receive and does receive the tube extending from the most proximal transitioning tube section (400); and,
a container mount assembly (300) is affixed, by container mount assembly (300) affixing means, to each of said plurality of vertical supports (120) most proximal to a container (500) or planting medium wherein a plant is or is to be located; the said container mount assembly (300) is in alignment with the upwardly extending vertical support (120).

3. An adjustable plant cage (1) depending from claim 2 and further comprising:
the said rigid or semi-rigid tubular material comprises metal or plastic tubing and tubing interconnecting parts; and,
where the plant cage (1) is used with a container (500) the container mount assembly (300) is a bracket formed to attach to a container (500) affixed, by container mount assembly (300) affixing means, to each of said plurality of vertical supports (120); the container mount assembly (300) is affixed to the vertical support (120) most proximal to a container (500) or the planting medium wherein a plant is or is to be located; the said container mount assembly (300) is in alignment with the upwardly extending vertical support (120).

4. An adjustable plant cage (1) depending from claim 3 and further comprising:
where the plant cage (1) is used with a container (500) the container mount assembly (300) bracket, in the kit, is comprised of a container mount coupling (310), comprising a straight coupling, a plug (320) and a u-channel (330); and,
the vertical support (120) most proximal to the container (500) is sized to and is received into the said container mount coupling (310); and,
the said plug (320) is sized to and is received upwardly into the said container mount coupling (310); and,
a plug aperture, formed in the plug (320), and a container aperture, formed in the top edge of the container, are aligned; and,
the said u-channel (330) is an open rectangular U-Channel having a u-channel (330) aperture in the closed side of the U-Channel opposing the open side; and, the u-channel (330) is placed against the underside of the top edge of the container with the u-channel (330) aperture in alignment with the plug aperture and container aperture with said alignment receiving the downwardly extending plug bolt (340) which is rigidly secured by bolt/nut interconnection by said nut (350).

5. An adjustable plant cage (1) depending from claim 2 and further comprising:
the said rigid or semi-rigid tubular material comprises metal or plastic tubing and tubing interconnecting parts; and,
where the plant cage (1) is used with a plant in earth or a potting mixture, each of the said plurality of vertical supports (120) are sized to and are received most proximal to the earth or a potting mixture, into the said container mount coupling (310); and a tubular spike (510) is sized to and is received upwardly into the said container mount coupling (310).

6. A plant cage kit comprising:
3 each Vertical Supports (120), 6 each cross section assemblies (200), 3 container mount assemblies (300), 3 straight couplings (310), 3 plugs (320), 3 u-channels (330), 3 bolts (340) and 3 nuts (350), 6 horizontal transitioning sections (400) comprising 3 outer tubes (410) and 3 inner tubes (420), 6 position holders (430), one container (500) and 3 steaks (510).
